(19) United States
(12) Patent Application Publication
(10) Pub. No.: US 2023/0059145 A1
(43) Pub. Date: Feb. 23, 2023

(54) METHOD AND SYSTEM FOR INCORPORATING GEOGRAPHICAL POSITIONS OF VEHICLES AVAILABLE FOR HIRE INTO A DIGITAL MAP

(71) Applicant: VULOG, NICE (FR)

(72) Inventor: François COLON, MARSEILLE (FR)

(73) Assignee: VULOG, NICE (FR)

(21) Appl. No.: 17/792,494

(22) PCT Filed: Jan. 14, 2021
(86) PCT No.: PCT/FR2021/050060

§ 371 Date: Jul. 13, 2022

(30) Foreign Application Priority Data
Jan. 14, 2020 (FR) FR2000339

(51) Int. Cl. G01C 21/36; G01C 21/34; G06Q 50/30

(52) U.S. Cl. CPC G01C 21/367; G01C 21/343; G06Q 50/30

(57) ABSTRACT

A method for displaying, on a digital map, the geographical position of vehicles available for hire, the method including the following steps: retrieving the real geographical position, at a time T0, of vehicles available for hire, for each of the vehicles: calculating, by a route calculation module, a route between: a starting point corresponding to the real geographical position of the vehicle at T0, and an arrival point defined with respect to the geographical position of a mobile terminal of a user, calculating, by a calculation module, an estimated geographical position of the vehicle at a time T2 on the calculated route, wherein T2>T0, and, at a time T1, displaying on the digital map the estimated geographical position of all or a portion of the vehicles, wherein T2>T1>T0.

### TECHNICAL FIELD

The invention relates to a method and a system for incorporating geographical positions of vehicles available for hire into a digital map.

The field of the invention relates in particular to methods making it possible to filter and/or select geographical positions of vehicles to be displayed on a digital map.

### BACKGROUND

Solutions are known that make it possible to hire a vehicle by means of a user mobile terminal. The LIBER® service is particularly known, the computer application of which allows people to hire a ride in cities in which the service is available. A hiring request is sent, from a user mobile terminal, to a server. This transmits the request to drivers located near the user. When one of them accepts the ride, the application indicates the estimated time of their arrival at the place of picking up the user. A digital map, displayed on the user's mobile terminal, allows the driver's location and route to be tracked in real time.

Document US2011/0112969 (ZAID) describes another vehicle hiring solution. A user transmits, from a smartphone-type mobile terminal, a hiring request to a remote computer server. The latter selects an available vehicle and transmits to the user, identification and position information of said vehicle. The position of the vehicle is generally visible on a digital map displayed on a graphic interface of the user terminal.

In these current systems, and as illustrated in FIG. 1, if a user U transmits, from their user terminal EQ_{U} and to the remote server SERV, a hiring request at a time T0, said server generates and displays on said terminal, a digital map generally indicating all the real geographical positions at T0, of the vehicles V₁-V₆ available for hire. The computer resources mobilized by the server SERV, the calculation times and the bandwidth on the network R are therefore high insofar as all the real geographical positions of the vehicles V₁-V₆ are incorporated into the digital map C displayed on a graphic interface of the user terminal. The user U will naturally select the vehicle V₁ which is closest to them. The choice of vehicles capable of being hired by the user U is therefore, in practice, particularly restricted.

An aim of the invention is to overcome this state of affairs. In particular, another aim of the invention is to propose a method making it possible to reduce the computer resources mobilized by a server, the calculation times and the bandwidth on the R network making it possible to display on a digital map, the geographical position of vehicles available for hire.

### SUMMARY

The solution proposed by the invention is a method for incorporating geographical positions of vehicles available for hiring into a digital map, said method comprising the following steps:
a) receiving at a time T0, from a user mobile terminal, the geographical position of said mobile terminal and a hiring request,
b) automatically calculating, by means of a calculation module, data defining a first geographical area centered on the geographical position of the mobile terminal received at time T0,
c) automatically calculating, by means of the calculation module, data defining a second geographical area included in the first geographical area and the center of which corresponds to the geographical position of the mobile terminal and the radius of which corresponds to a distance, which distance is automatically defined or is included in the hiring request by being entered by said user from an interface of the mobile terminal,
d) receiving the real geographical positions, at the time T0, of vehicles available for hire, which geographical positions are received from equipment embedded in said vehicles or are received from mobile terminals of users using said vehicles,
e) automatically performing, by means of a computer processing module, a first selection of vehicles available for hire, the real geographical position of which at time T0, is included in the first geographical area,
f) for each of said vehicles selected during the first selection:
   f1) automatically calculating, by means of a route calculation module, a route between: a starting point corresponding to the real geographical position of said vehicle at T0; and an arrival point defined with respect to the geographical position of the mobile terminal,
   f2) automatically calculating, by means of the calculation module, an estimated geographical position of the vehicle at a time T2 on the calculated route, where T2>T0,
g) automatically performing, by means of the computer processing module, a second selection of vehicles available for hire, the estimated geographical position of which is included in the second geographical area,
h) at a time T1 such that T2>T1>T0: automatically incorporating in a digital map displayed on a graphic interface of the mobile terminal, only the estimated geographical positions of said vehicles at the time T2 and which are selected during the second selection.

The map which is displayed at the time T1 no longer indicates the real position of the vehicles as in the solutions of the prior art, but an estimated (future) position of said vehicles at a time T2>T1. T2 being the time taken by the vehicles if they moved towards the user following the calculated route. The selections made on the vehicles make it possible to reduce the number of positions displayed on the digital map and in fact make it possible to reduce the computer resources mobilized, the calculation times and the bandwidth on the network. Notwithstanding this reduction, the map will however be able to display the positions of a greater number of vehicles located close to the user such that a wider choice is offered to the user.

Other advantageous characteristics of the invention are listed below. Each of these characteristics can be considered individually or in combination with the noteworthy characteristics defined above, and can form the subject, if necessary, of one or more divisional patent applications:
According to an embodiment, the method comprises the following steps: - automatically calculating, by means of the calculation module, and for each route calculated in step fl), the travel time of the vehicle concerned by said route, between the point of departure and point of arrival; - making a third selection of vehicles available for hire, the calculated travel time of which is equal to or less than a specified timeframe; - performing step h) only for the vehicles selected during the third selection and the calculated travel time of which is equal to or less than the determined timeframe.
According to an embodiment, the timeframe used to make the third selection is a timeframe entered from an interface of the mobile terminal, which timeframe is included in the hiring request.
According to an embodiment, the time T2 corresponds to the time T0 to which is added a timeframe entered from an interface of the mobile terminal, which timeframe is included in the hiring request.
According to an embodiment, the radius of the first geographical area is calculated automatically and depends on the timeframe specified and included in the hiring request.
According to an embodiment, the radius of the second geographical area is defined automatically by considering an average distance calculated based on collection distances usually entered by users.
According to an embodiment, in step h), the estimated geographical position of each vehicle at the time T2 is displayed on a graphic interface of the user mobile terminal, in the form of a selectable marker, each said marker being associated with an ID of the vehicle concerned.

Another aspect of the invention relates to a system comprising at least one mobile terminal of a user and a remote computer server, configured for the implementation of the steps of the method according to one of the preceding characteristics.

Also, another aspect of the invention relates to a computer program product comprising code instructions for executing a method according to one of the preceding characteristics, when it is executed by a remote a computer server.

### BRIEF DESCRIPTION OF THE FIGURES

Other advantages and characteristics of the invention will become clearer upon reading the description of the following preferred embodiment, by reference to the appended drawings, provided for guidance as non-limiting examples, wherein:

FIG. 1 above illustrates an example of a digital map on which are indicated the geographical positions of vehicles available for hire,

FIG. 2 illustrates an example of a digital map on which are indicated geographical positions of vehicles available for hire at a time T0; a first geographical area and a second geographical area, centered on the location of a user mobile terminal, are also represented,

FIG. 3 shows the map of FIG. 2 on which vehicle routes are illustrated,

FIG. 4 shows the map of FIG. 3 on which are illustrated the estimated geographical positions of vehicles at a time T2>T0,

FIG. 5 is an example of a digital map obtained according to the method which is the subject of the invention.

FIG. 6 represents an overview diagram of the main steps of a method according to the invention.

FIG. 7 schematizes the arrangement of different elements of a user terminal, of computer equipment embedded in a vehicle and of a remote computer server.

### DETAILED DESCRIPTION OF THE EMBODIMENTS

The method and the system of the invention generate handlings of physical elements, in particular signals (electric or magnetic) and digital data, capable of being stored, transferred, combined, compared, etc., and making it possible to achieve a desired result.

The invention implements one or more computer applications executed by computer equipment or servers. For clarity, it must be understood in the sense of the invention that “a piece of equipment or server does something” means “the computer application executed by a processing unit of the equipment or server does something”. Just as “the computer application does something” means “the computer application executed by the processing unit of the equipment or server does something”.

Also, for clarity, the present invention makes reference to one or more “logical computer processes”. The latter correspond to the actions or results obtained by the execution of instructions from different computer applications. Also, it must be understood in the sense of the invention that “a logical computer process is adapted to do something” means “the instructions of a computer application executed by a processing unit do something”.

Also, for clarity, the following clarifications are made to certain terms used in the description and claims:
“Computer resource” can be understood in a non-limiting way, as: component, hardware, software, file, computer network connection, amount of RAM memory, hard drive space, bandwidth, processor speed, number of CPUs, etc.
“Computer server” can be understood in a non-limiting way as: computer device (hardware or software) comprising computer resources to perform the functions of a server and which offers services, computer, plurality of computers, virtual online server, virtual cloud server, virtual server on a platform, virtual server on a local infrastructure, server networks, cluster, node, server farm, node farm, etc.
“Request” means an execution order which can follow a communication protocol and comprising input parameters (question, information, etc.) and possibly return parameters (answer, information, etc.), which can be in a format related to the protocol used.
“Processing unit” can be understood in a non-limiting way as: processor, microprocessors, CPU (for Central Processing Unit), etc.
“Computer application” can be understood as: software, computer program, computer firmware, lines of executable code, software, etc.
“Data network” can be understood in a non-limiting way as: internet network, cellular network, satellite network, etc. It is a set of computer equipment connected together to exchange, securely or not, information and/or data according to a communication protocol (ISDN, Ethernet, ATM, IP, CLNP, TCP, HTTP, etc.).
“Database” can be understood in a non-limiting way as a structured and organized set of data recorded on media accessible by computer equipment and which can be interrogated, read and updated. Data can be inserted, retrieved, modified and/or destroyed. Management and access to the database can be provided by a set of computer applications which constitute a database management system (DBMS).
“Service” can be understood in a non-limiting manner as all the functionalities proposed and ensured by a server and/or by at least one piece of computer equipment. The service can comprise, for example, the following functionalities: hiring of a vehicle, location (real and/or estimated) of a vehicle, locking/unlocking of a vehicle, etc.
“Shared vehicle” can be understood in a non-limiting manner as a hire vehicle or a car-sharing vehicle, made available to “customers” or members. The vehicle can be: an autonomous car (capable of driving on the road, without the intervention of a driver), a car or a truck (internal combustion and/or electric engine), a motorized two-wheeler (internal combustion and/or electric engine), a bicycle (conventional or with electric assistance), a scooter (conventional or with electric assistance), a skateboard, an electric unicycle, a Segway, a boat, etc. When a user uses a shared vehicle, they can be charged a certain amount generally depending on the number of kilometers traveled and/or the time of use of the vehicle and/or the model or type of vehicle.
“Digital map” can be understood as a real or illustrated representation of a geographical area. The digital map is intended to be displayed on a screen or another graphic interface of a piece of computer equipment. The digital map is generated using a map generator of mapping software type, for example, Google Map® software.
Such as used in this case, unless otherwise specified, the use of ordinal adjectives “first”, “second”, etc., to describe an object simply indicates that different occurrences of similar objects are mentioned and does not imply that the objects thus described must be in any given sequence, whether in time, space, classification, or any other way.

### SYSTEM

A system for implementing the method according to the invention comprises a mobile user terminal EQu and a remote server SERV, configured for the implementation of the steps of said method, and more particularly for displaying the geographical position of vehicles V₁-V₆ available for hire.

By way of illustrative example, vehicles V₁-V₆ are autonomous vehicles having a status “available for reservation”. It could also be vehicles of the taxi type, a chauffer-driven passenger vehicle, or vehicles of which the drivers are registered with the LIBER® service.

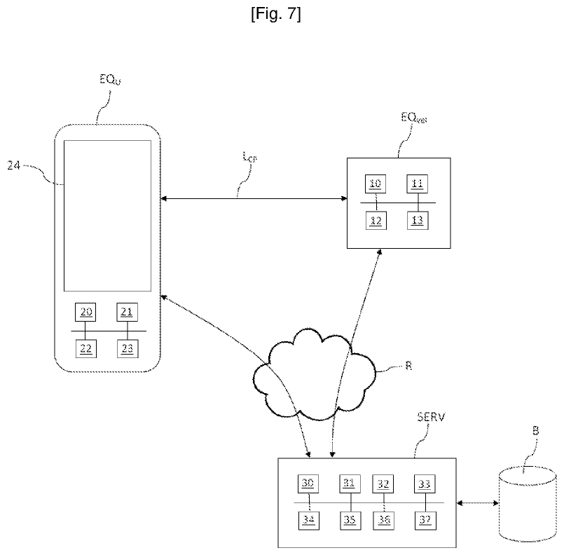

Referring to FIG. 7, each vehicle Vᵢ preferably integrates a piece of embedded computer equipment EQ_{VEi} . This equipment can for example be part of a telematic box enabling the vehicle to exchange information (e.g. geographical position, speed, etc.) with a remote server SERV, through a data network R. The computer equipment EQ_{VEi} can also be dedicated equipment, independent of the telematic box.

Each piece of embedded equipment EQ_{VEi} comprises, among other computer resources, a processing unit 10, a signal transmitter/receiver 11, and one or more memories 12 in which a computer application is stored. The EQ_{VEi} embedded equipment also comprises a communication interface 13. These different elements are connected at least to the processing unit 10 by a communication bus.

The instructions of the computer application stored in the memory 12, when they are executed by the processing unit 10, make it possible to carry out the steps of the method which are described above in the description. The memory 12 is also adapted for storing a certain amount of other information.

The transmitter/receiver 11 is adapted for exchanging signals, via a short-range wireless connection L_{CP}, with the user terminal EQ_{U} described above in the description and/or with the embedded equipment of other vehicles. The connection L_{CP} has, for example, a range less than or equal to 100 meters. The signals exchanged are preferably infrared signals or radiofrequency signals. The connection L_{CP} preferably uses a communication protocol of the following family Bluetooth, Wi-Fi, Z-Wave, ANT, ZIGBEE, Infrared.

The communication interface 13, for example GSM, 3G, 4G or Wi-Fi, is adapted for establishing a wireless communication connection with the communication interface 32 of the remote server SERV, through the data network R.

Each vehicle V₁-V₆ is associated with a unique ID number (for example, a numeric code or an alphanumeric code) stored in the database B.

At a given time, the vehicles V₁-V₆ can be:
with a status called “Available”: the vehicle is parked and/or not hired,
with a status called “Unavailable”: either the vehicle is parked but is already hired by a user (“Unavailable-Hired” status), or the vehicle is in operation (“Unavailable-in operation” status).

The user U has at least one mobile terminal EQ_{U}. The latter preferably consists of a smartphone, a digital tablet, a laptop, etc.

In FIG. 7, the terminal EQ_{U} integrates a processing unit 20, a signal transmitter/receiver 21 and one or more memories 22 in which a computer application for implementing the service (“service application”) is stored, a communication interface 23 and a graphic interface 24 of the touchscreen type. These different elements are connected at least to the processing unit 20 by a communication bus. It also comprises the computer resources making it possible to carry out the steps of the method of the invention. The transmitter/receiver 21 is similar to that of the embedded equipment EQ_{VEi} . The communication interface 23, for example GSM, 3G, 4G or Wi-Fi, is adapted for establishing a wireless communication connection with the communication interface 32 of the remote server SERV, through the data network R.

According to an embodiment, to download the service application, and to have access rights to the service, the user U must first register with a rights management server beforehand, which can or cannot be the above-mentioned remote server. According to an embodiment, the registration of the user U is carried out with a web service of the remote server SERV associated with the service. The registration comprises the storing of a user ID and/or an ID of the terminal EQ_{U}. This can be a port, an IP address, a MAC address or any other address or combinations allowing the terminal EQ_{U} to be identified. According to an embodiment, the user U is pre-registered from software and is known because an ID is stored in a database B.

In FIG. 7, the server SERV integrates a processing unit 30, one or more memories 31, a communication interface 32, a location module 33, a route calculation module 34, a calculation module 35, a digital map generator 36, a computer processing module 37, which are mutually connected via a bus. One or more computer applications are stored in the memory(ies) 31 and of which the instructions, when they are executed by the processing unit 30, make it possible to perform the functionalities described above in the description.

The location module 33, route calculation module 34, calculation module 35, processing module 37 and map generator 36 modules are hardware and/or software components of the server SERV.

The server SERV regularly updates, preferably in real time, the database B. This database groups together in particular: the ID of each vehicle Vᵢ, their status (“Available” or “Unavailable”), and their geographical position. Other information and/or data can be grouped together in the database BAS, if necessary. The database B can be stored in a memory area of the server SERV or be remote from said server.

Information on the status of a vehicle Vᵢ, is transmitted to the server SERV in real time or at predefined time intervals (for example, every 5 minutes). This information can be transmitted to the server SERV, for example from the embedded equipment EQ_{VEi} of the vehicle V, following a detection of an event. This event is, for example, generated by an action by the user or the driver on a specific command arranged on the dashboard of the vehicle Vᵢ. This command can be actuated when a user has parked their vehicle and released the vehicle or a that a driver has finished a ride. The status thus changes from “Unavailable” to “Available”.

When the server SERV receives a hiring request from the user U and that it can grant this request (i.e. that a vehicle is available for hire), said server changes the status of a vehicle from “Available” to “Unavailable”. This hiring request is preferably generated via the user mobile terminal EQ_{U}.

The geographical position of each of the vehicles V₁-V₆ can be obtained by satellite

(GPS or Galileo system) or by a triangulation system (for example, a system using the cells of a 4G network) or by a combination of both location systems. The equipment EQ_{VEi} of a vehicle Vᵢ, advantageously comprises a component, for example a GPS component, making it possible to obtain geolocation information which can be retrieved by the location module 33 of the server SERV. The location module 33 can automatically retrieve this information by interrogating in real time or at regular time intervals (for example, every 5 minutes), the equipment EQvE, of the vehicles. The equipment EQ_{VEi} of the vehicles can also automatically transmit this information to the location module 33 (without responding to an interrogation request), in real time or at regular time intervals (for example, every 5 minutes). The geographical position of each vehicle V, is thus stored in the database B.

According to an alternative, the geographical position of a vehicle Vᵢ, can correspond to the geographical position (obtained by satellite and/or by a triangulation system) of a mobile terminal (for example, a smartphone) of a user or a driver using said vehicle. This geographical position is automatically retrieved by the location module 33 or transmitted to it.

The geographical position of the terminal EQ_{U} can be obtained in the same way. By satellite and/or by a triangulation system. The equipment EQ_{U} advantageously comprises a component, for example a GPS component, making it possible to obtain geolocation information which can be retrieved by the location module 33 or transmitted to it.

### METHOD

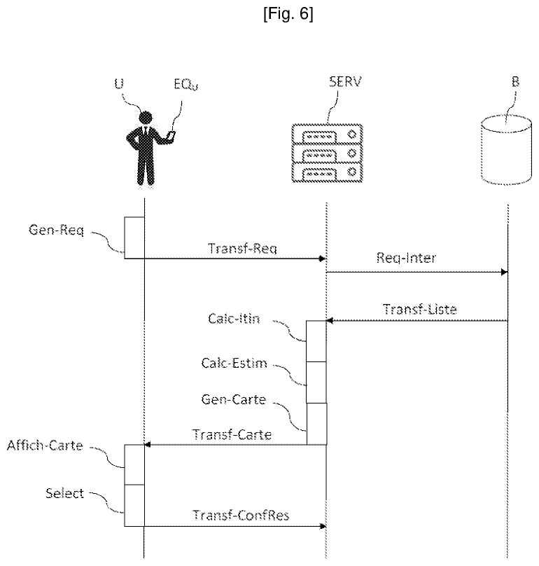

FIG. 6 illustrates steps of a method according to the invention. The user U wishes to hire a vehicle. According to an embodiment, the user U generates, from their terminal EQ_{U}, a hiring request (Gen_Req) indicating that they wish to retrieve a vehicle. The user can also specify that they wish to retrieve a vehicle within a determined timeframe and at a determined distance from their position. For example, the user U wishes to have a vehicle within 15 minutes maximum, and at a maximum of 200 meters from their position. This request is generated by launching the service application and by entering the timeframe and distance information from the graphic interface 24 of the terminal EQ_{U}.

According to an embodiment, this hiring request is transmitted (Transf_Req) to the server SERV, from the terminal EQ_{U}, at a time T0 (for example, at 4:00 p.m.). The hiring request can directly contain the geographical position of the terminal EQ_{U}. Alternatively, upon receipt of the hiring request, the location module 33 of the server SERV can automatically retrieve this geographical position.

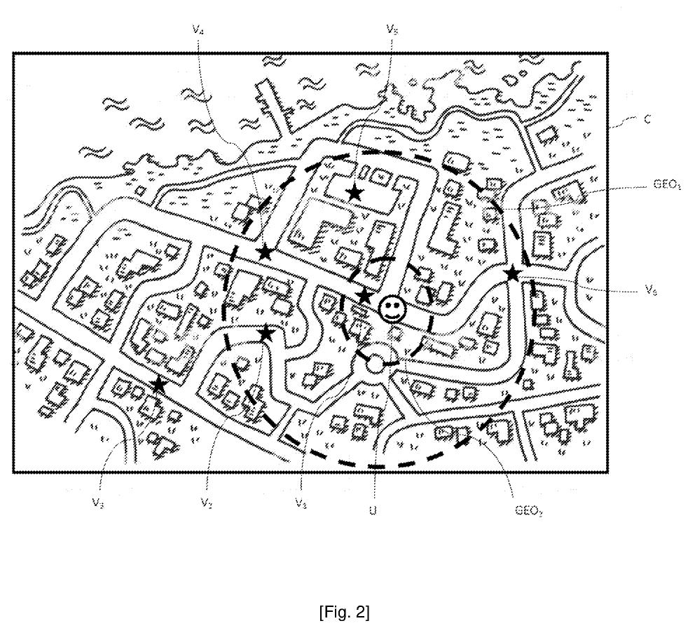

According to an embodiment, when the server SERV receives the hiring request at the time T0, it interrogates (Req_Inter) the database B to identify the vehicles available for hire, i.e. having an “Available” status at T0. In the example illustrated in FIG. 2, all the vehicles V₁-V₆ are considered as available for hire. The database B returns to the server SERV the list (or the IDs) of the vehicles V i-V₆ (Transf Liste) with their real geographical position at T0. Alternatively, upon receipt of the list, the location module 33 of the server SERV can interrogate each vehicle of said list to retrieve their real geographical position at T0.

To reduce the computer resources mobilized by the server SERV, the calculation times and the bandwidth on the network R, it is advantageous to limit the search and the processing to the vehicles located at a reasonable distance from the user. By “Reasonable”, this means a distance such that the vehicles have a good probability of reaching the user U within the timeframe indicated in the hiring request. The extent of this distance can be determined by an algorithm considering, in particular, the type of vehicle, and the type of area where the user is located (urban, rural, etc.). For example, in an urban area, it can be considered that a vehicle of the car type drives on average at 30 km/h. A rule of proportionality makes it possible to estimate that within a timeframe D, the vehicle travels 30×D/60 km. For example, if the timeframe is 15 min, then this distance is approximately 7.5 km. The search and processing will thus be limited to vehicles located within a radius of 7.5 km around the geographical position of the user.

Also, upon receipt of the hiring request, the calculation module 35 of the server SERV advantageously automatically calculates data defining a first geographical area centered on the geographical position of the terminal EQ_{U} at the time T0. This geographical area is illustrated in FIG. 2 and has the reference GEO₁. The center of this area corresponds to the position of the EQ_{U} terminal and its radius corresponds to the above-mentioned “reasonable” distance (e.g.: 7.5 km).

The only vehicles selected will be those which, at T0, are available for hiring and have a real geographical position included in the first area GEO₁. In the example of FIG. 2, only the vehicles V₁, V₂, V₄, Vs and V₆ will be selected, the vehicle V₃ being located, at T0, outside the first area GEO₁. According to an embodiment, this selection is made by the processing module 37 of the server SERV, when said server receives the list of vehicles V₁-V₆ (Transf_Liste) with their real geographical position at T0. According to another embodiment, the data relating to the first area GEO _{I} are integrated into the interrogation request (Req_Inter), such that only the real IDs and geographical positions of the vehicles V₁, V₂, V₄, V₅ and V₆ are retrieved in the database B.

For each vehicle V₁-V₆, the server SERV automatically calculates a route (FIG. 6; Calc_Itin) between: a point of departure corresponding to the real geographical position of said vehicle at T0; and a point of arrival defined with respect to the geographical position of the terminal EQ_{U}. According to a preferred embodiment, this calculation is performed only for the vehicles V₁, V₂, V₄, V₅ and V₆ included in the first area GEO₁. The calculation of the routes is done by the route calculation module 34 (for example, of the Mapquest® or Google Maps® type) of the server SERV.

The point of arrival can coincide with the geographical position of the terminal EQ_{U}. According to an embodiment, the calculation module 35 of the server SERV, advantageously calculates data defining a second geographical area centered on the geographical position of the terminal EQ_{U} at the time T0. This second geographical area is illustrated in FIG. 2 and has the reference GEO2 The center of this area corresponds to the position of the terminal EQ_{U} and its radius corresponds to the collection distance which is indicated in the hiring request (Gen_Req) and at which the user agrees to retrieve the vehicle. Continuing with the above example, the radius of the second area GEO2 is 200 meters. In this embodiment, the arrival point corresponds to an entry point of the vehicle into the second area GEO2 In the case where the arrival point coincides with the position of the terminal EQ_{U}, it can be considered that the second area GEO2 has a zero radius.

If the hiring request does not contain a collection distance, the radius of the second area GEO₂ can be defined automatically by the server SERV, for example by taking into account an average collection distance calculated based on collection distances usually provided by users of the service.

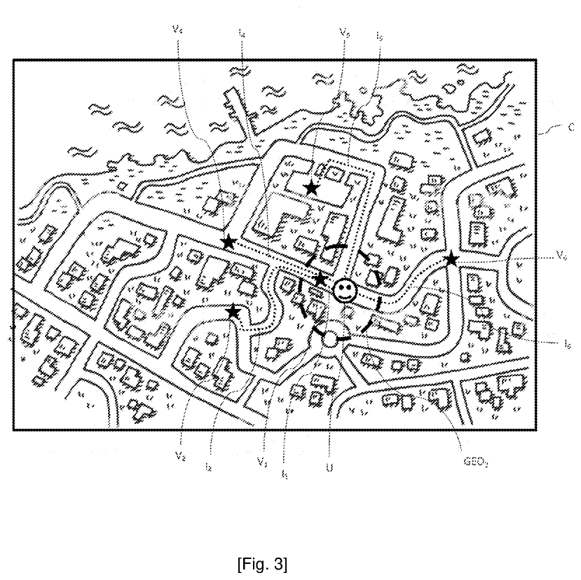

According to a preferred embodiment, for each vehicle V₁, V₂, V₄, V₅ and V₆, the server SERV, and more specifically its route calculation module 34, automatically develops the fastest and/or the shortest route between the point of departure and the point of arrival. In one example, the calculation of the routes considers the road traffic so as to propose the fastest path to arrive at the point of arrival. These routes are schematized and referenced respectively I₁, I₂, I₄, I₅, I₆ in FIG. 3.

For each vehicle V₁, V₂, V₄, V₅ and V₆ for which a route has been calculated, the calculation module 35 of the server SERV automatically calculates an estimated geographical position (Calc_Estim) of said vehicle at a time T2>T0 on said route. According to an embodiment, this time T2 corresponds to the time T0 to which is added the timeframe indicated in the hiring request (Gen_Req) and during which the user wishes to retrieve the vehicle. Returning to the above-mentioned example, the user generates the hiring request at T0=4:00 p.m. indicating that they wish to have a vehicle in 15 minutes, hence T2=4:15 p.m. In other words, at T0 (disregarding the calculation latencies), the server SERV will predict what the future position of the vehicle V, will be on the route I, at the time T2. This prediction preferably considers the nature of the vehicle V, (and therefore a predefined average movement speed) and the state of the road traffic on the route I,. If the hiring request does not contain a timeframe, the time T2 can be predefined automatically by the server SERV, for example by considering an average timeframe calculated based on the timeframes usually entered by users of the service.

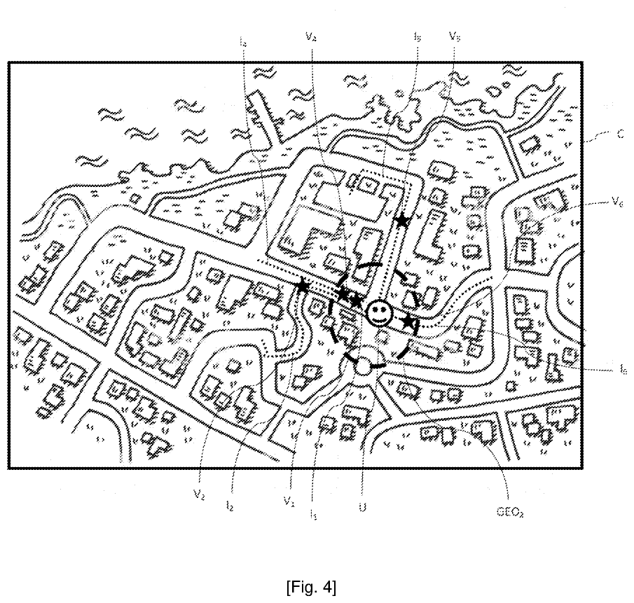

The map generator 36 will then generate a digital map (Gen_Map) on which will be automatically incorporated, only the estimated geographical positions of the vehicles V₁, V₂, V₄, V₅ and V₆. The data from this map and from these positions are transmitted to the terminal EQ_{U} (Transf_Carte). The latter displays (Display_Map) on its interface 24, the map and only the estimated geographical positions of the vehicles V₁, V₂, V₄, Vs and V₆. Such a map C can be seen in FIG. 4.

The digital map C is displayed on the terminal EQ_{U} at a time T1<T2. This time T1 can correspond to the time T0, disregarding the calculation latencies (T1=T0). By considering the possible calculation latencies, T1 can be slightly greater than T0, for example by a few milliseconds or a few seconds. The map C is then displayed on the terminal EQ_{U} with a delay with respect to the sending of the hiring request (Transf Req).

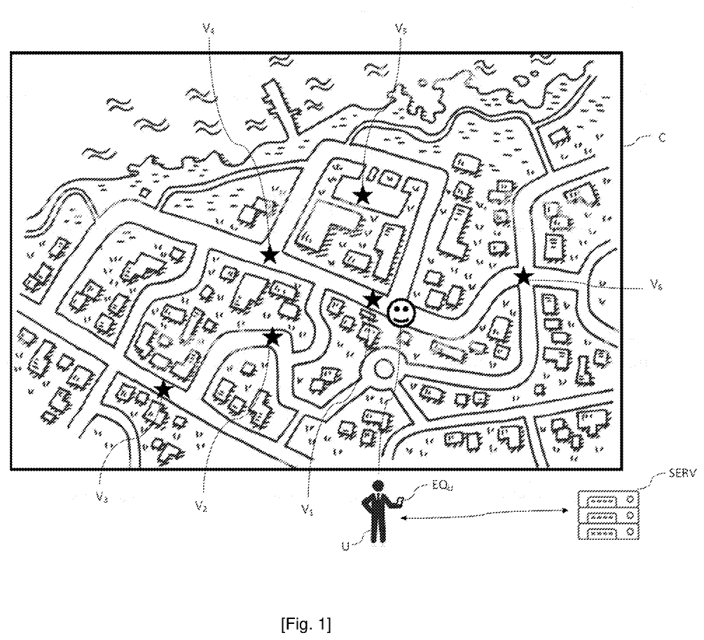

Compared to the map of FIG. 1, the map of FIG. 4 displays a smaller number of vehicles, such that the computer resources mobilized by the server SERV are reduced, as well as the calculation times and the bandwidth on the network R. But, the vehicles of FIG. 4 are closer to the position of the user U, such that the latter has more choice.

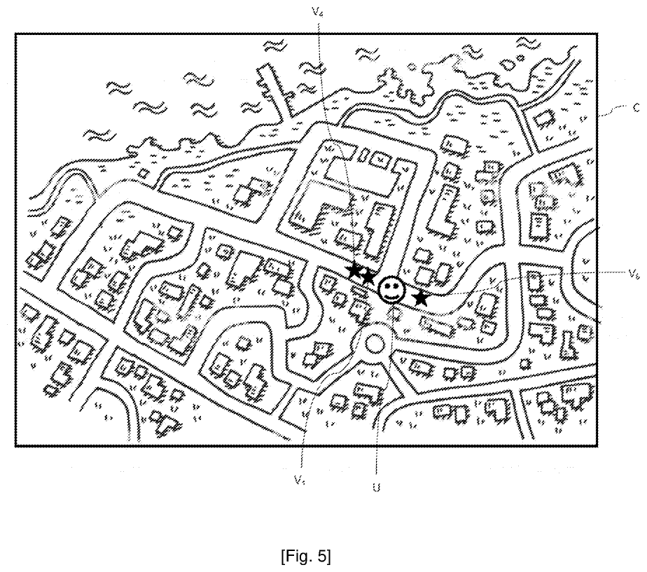

According to an embodiment, the only vehicles of which the estimated geographical position will be displayed are those of which the estimated position is included in the second area GEO₂ To do this, the server SERV selects only the vehicles of which the estimated geographical position is included in the second area GEO₂ In the example of FIG. 5, only the vehicles V₁, V₄ and V₆ will be selected, the vehicles V₂ and Vs being located, at T2, outside the second area GEO₂ According to an embodiment, this second selection is made by the processing module 37 of the server SERV, after said server has calculated the estimated geographical positions (Calc_Estim) and before the transfer of the map data (Transf Map).

The second selection can be based on an analysis and a comparison of the data delimiting the second area GEO₂ and those defining the estimated positions of the vehicles.

According to another embodiment, a selection is made based on an analysis of the travel times of the vehicles V₁, V₂, V₄, V₅, V₆ on the routes I₁, I₂, I₄, I₅, I₆. The calculation module 35 of the server SERV calculates, for each route the travel time of the vehicle concerned Vᵢ, between the point of departure and the point of arrival (i.e. the entry into the second geographical area GEO₂, i.e. the geographical position of the terminal EQ_{U}). Only the vehicles will be selected of which the travel time is equal to or less than the timeframe determined in the hiring request (Gen_Req), i.e. 15 minutes, using the above-mentioned example. If the hiring request does not contain such a timeframe, this can be determined automatically by the server SERV, for example by considering an average timeframe calculated based on the timeframes usually entered by users of the service. Considering the example of FIG. 5, the calculation module 35 calculates that only the vehicles V₁, V₄ and V₆ have a travel time less than or equal to the determined timeframe. The other vehicles V₂ and V₅ have a greater travel time. The vehicles V₁, V₄ and V₆ will then be selected such that their estimated position is displayed on the map C.

The estimated geographical position of each vehicle V₁, V₄, V₆ is preferably displayed on the graphic interface 24 of the terminal EQ_{U}, in the form of a selectable marker, being presented, for example, in the form of a point or an icon (e.g. a star in FIG. 5). Other information can be displayed in addition to the marker and in particular identification information, allowing the user U to identify a vehicle V, very simply and very quickly. This information can be: the code (numerical or alphanumeric) of its license plate, and/or its model and/or its color and/or its image or photo, etc.

Each marker is advantageously associated with the ID of the vehicle V, concerned V₁, V₄, V₆. These IDs are retrieved by the server SERV in the database B and associated with the data transmitted to the Transf Carte step.

Referring to FIG. 6, when the user U selects (Select) one of the markers, for example that of the vehicle V₆, the terminal EQ_{U} generates and transmits to the computer server SERV, a reservation confirmation (Transf_ConfRes). This confirmation contains the vehicle ID V₆.

Upon receipt of the hiring confirmation, the server SERV will thus hire the vehicle V₆. This will then begin its journey to reach its estimated position. If the vehicle V₆ is an autonomous vehicle, the server SERV transmits to the equipment EQ_{VE6}, a command to launch its journey along the route 16 to its estimated position. If the vehicle V₆ is a vehicle of the taxi or chauffeur-driven private car type, the server SERV transmits a message to the driver (for example, by email or text message), to indicate to them, for example, to go to the estimated position by following the route I₆. According to an embodiment, the map C displays information on the location in real time of the vehicle V₆ on the route I₆, such that the user U can follow their movement in real time.

Upon receipt of the hiring confirmation by the server SERV, in the database B, the status of the vehicle V₆ will change from “Available” to “Unavailable”, such that no other user will be able to use it. The user U is thus assured that the vehicle V₆ will be available when it reaches its estimated position. The words “Unavailable for hire” can further be displayed on a graphic interface installed visibly on the vehicle V₆.

In addition to or in substitution for the modification of the status of the vehicle V₆, the server SERV can make said vehicle physically unusable by people other than the user U. Indeed, the vehicle V₆ can be equipped with a remote locking/unlocking device. It can, for example, be an engine immobilizer device controlled by the embedded equipment EQVE6. The server SERV then transmits to the equipment EQVE6, a command to activate the locking device, temporarily making the vehicle V₆ unusable. When the user U accesses the vehicle V₆, they can transmit to the embedded equipment EQVE6, from their terminal EQ_{U}, for example via the short-range wireless connection L_{CP}, a command to deactivate the locking device, making said vehicle usable. Alternatively, the server SERV can detect, in particular by geolocation, that the position of the user (i.e. of their equipment EQ_{U}), coincides with that of the vehicle V₆. Consequently, it is the server SERV which transmits the deactivation command to the equipment EQ_{VE6}.

### COMPUTER PROGRAM PRODUCT

Also, according to another aspect, the invention relates to a computer program product comprising code instructions for the execution of the method according to the invention, when it is executed by the mobile terminal EQ_{U}.

The arrangement of the different elements and/or means and/or steps of the invention, in the embodiments described above, must not be understood as requiring such an arrangement in all the implementations. For example, the geographical areas GEO₁ and GEO₂ can be defined in a shape other than a circle, for example in the shape of a rectangle or a square. Such areas are then defined, not by the length of their radius, but by the length of their sides and/or diagonals or half-diagonals. Also, the location and/or route calculation and/or calculation and/or processing module and/or the map generator can be hardware and/or software components of the terminal EQ_{U}. All or some of the steps associated with these elements are thus implemented in the terminal EQ_{U}.

Finally, one or more characteristics and/or steps outlined only in one embodiment can be generalized to the other embodiments. Furthermore, one or more characteristics and/or steps outlined only in one embodiment can be combined with one or more other characteristics and/or steps outlined only in another embodiment.

1-9. (canceled)

10. A method for incorporating geographical positions of vehicles available for hire into a digital map, the method comprising the following steps:
a) receiving at a time T0, from a user mobile terminal, the geographical position of said mobile terminal and a hiring request,
b) automatically calculating, by a calculation module, data defining a first geographical area centered on the geographical position of the mobile terminal received at time T0,
c) automatically calculating, by the calculation module, data defining a second geographical area included in the first geographical area and the center of which corresponds to the geographical position of the mobile terminal and a radius of which corresponds to a distance, which distance is automatically defined or is included in the hiring request by being entered by said user from an interface of the mobile terminal,
d) receiving real geographical positions, at the time T0, of vehicles available for hire, which geographical positions are received from equipment embedded in said vehicles or are received from mobile terminals of users using said vehicles,
e) automatically performing, by a computer processing module, a first selection of vehicles available for hire, the real geographical position of which at time T0 is included in the first geographical area,
f) for each of said vehicles selected during the first selection:
f1) automatically calculating, by a route calculation module, a route between: a point of departure corresponding to the real geographical position of said vehicle at T0; and a point of arrival defined with respect to the geographical position of the mobile terminal,
f2) automatically calculating, by the calculation module, an estimated geographical position of the vehicle at a time T2 on the calculated route, where T2>T0,
g) automatically performing, by the computer processing module, a second selection of vehicles available for hire, the estimated geographical position of which is included in the second geographical area,
h) at a time T1 such that T2>T1≥T0: automatically incorporating in a digital map displayed on a graphic interface of the mobile terminal, only the estimated geographical positions of said vehicles at the time T2 and which are selected during the second selection.

11. The method according to claim 10, further comprising the following steps:
calculating automatically, by the calculation module, and for each route calculated in step f1), the travel time of the vehicle concerned by said itinerary, between the point of departure and the point of arrival,
making a third selection of vehicles available for reservation whose calculated travel time is equal to or less than a determined time,
performing step h) only for the vehicles selected during the third selection and the calculated travel time of which is equal to or less than the determined timeframe.

12. The method according to claim 11, wherein the timeframe used to make the third selection is a timeframe entered from an interface of the mobile terminal, which timeframe is included in the hiring request.

13. The method according to claim 10, wherein the time T2 corresponds to the time T0 to which is added a timeframe entered from an interface of the mobile terminal, which timeframe is included in the hiring request.

14. The method according to claim 13, wherein the radius of the first geographical area is calculated automatically and depends on the timeframe entered and included in the hiring request.

15. The method according to claim 10, wherein the radius of the second geographical area is defined automatically by an average distance calculated based on the collection distances usually entered by users.

16. The method according to claim 10, wherein in step h), the estimated geographical position of each vehicle at the time T2 is displayed on the graphic interface of the user mobile terminal in the form of a selectable marker, each said marker being associated with an ID of the vehicle concerned.

17. A system, comprising: a mobile terminal of a user and a remote computer server, configured for the implementation of the steps of the method of claim 10.

18. A computer program product comprising code instructions for the execution of a method according to claim 10, when it is executed by a remote computer server.

19. The method according to claim 11, wherein the time T2 corresponds to the time T0 to which is added a timeframe entered from an interface of the mobile terminal, which timeframe is included in the hiring request.

20. The method according to claim 12, wherein the time T2 corresponds to the time T0 to which is added a timeframe entered from an interface of the mobile terminal, which timeframe is included in the hiring request.

21. The method according to claim 11, wherein the radius of the second geographical area is defined automatically by an average distance calculated based on the collection distances usually entered by users.

22. The method according to claim 12, wherein the radius of the second geographical area is defined automatically by an average distance calculated based on the collection distances usually entered by users.

23. The method according to claim 13, wherein the radius of the second geographical area is defined automatically by an average distance calculated based on the collection distances usually entered by users.

24. The method according to claim 14, wherein the radius of the second geographical area is defined automatically by an average distance calculated based on the collection distances usually entered by users.

25. The method according to claim 11, wherein in step h), the estimated geographical position of each vehicle at the time T2 is displayed on the graphic interface of the user mobile terminal, in the form of a selectable marker, each said marker being associated with an ID of the vehicle concerned.

26. The method according to claim 12, wherein in step h), the estimated geographical position of each vehicle at the time T2 is displayed on the graphic interface of the user mobile terminal, in the form of a selectable marker, each said marker being associated with an ID of the vehicle concerned.

27. The method according to claim 13, wherein in step h), the estimated geographical position of each vehicle at the time T2 is displayed on the graphic interface of the user mobile terminal, in the form of a selectable marker, each said marker being associated with an ID of the vehicle concerned.

28. The method according to claim 14, wherein in step h), the estimated geographical position of each vehicle at the time T2 is displayed on the graphic interface of the user mobile terminal, in the form of a selectable marker, each said marker being associated with an ID of the vehicle concerned.

29. The method according to claim 15, wherein in step h), the estimated geographical position of each vehicle at the time T2 is displayed on the graphic interface of the user mobile terminal, in the form of a selectable marker, each said marker being associated with an ID of the vehicle concerned.
